(19) United States
(12) Patent Application Publication
(10) Pub. No.: US 2025/0220073 A1
(43) Pub. Date: Jul. 3, 2025

(54) METHOD AND SYSTEM FOR CONSTRUCTING CLOSED PEER-TO-PEER NETWORK FOR DIGITAL SIGNAGE

(71) Applicant: Jae Goo LEE, Seoul (KR)

(72) Inventor: Jae Goo LEE, Seoul (KR)

(21) Appl. No.: 18/852,403

(22) PCT Filed: Mar. 6, 2023
(86) PCT No.: PCT/KR2023/003021

§ 371 Date: Sep. 27, 2024

(30) Foreign Application Priority Data
Mar. 30, 2022 (KR) 10-2022-0039444

(51) Int. Cl. H04L 67/1042; H04L 41/0803

(52) U.S. Cl. CPC H04L 67/1042; H04L 41/0803

(57) ABSTRACT

The present invention relates to a method and device for constructing a closed peer-to-peer network for digital signage, and comprises the steps, performed by an operating device, of: receiving, from a first terminal, a construction request signal for constructing a first network, which is a closed peer-to-peer network, by using a plurality of terminals including the first terminal and at least one second terminal; issuing a unique ticket according to the construction request signal; transmitting the unique ticket to the plurality of terminals; generating a terminal list for the plurality of terminals and transmitting the terminal list to the plurality of terminals; and constructing the first network with the plurality of terminals. The present invention can also be applied as other embodiments.

### TECHNICAL FIELD

The present invention relates to a method and system for constructing a closed peer-to-peer network for digital signage.

### BACKGROUND ART

Digital signage is outdoor advertising using digital information display on a billboard in which advertisement content can be managed through a communication network from a control center. Recently, the most common types of digital signage include outdoor digital signage installed on building exterior walls or electronic billboards, and indoor digital signage installed on interior walls of shopping malls or made small in the form of a stand-up signboard.

The digital signage operates by repeatedly showing various advertisement videos while changing the content, and currently, it operates by media operators for digital signage providing advertisers with log reports on content playback, and thus advertisers rely solely on the log reports provided by the media operators. As a result, issues regarding the reliability of the log reports may arise. Therefore, advertisers require reliable log reports that more objectively verify whether the content requested by the advertisers has been shown at the contracted times the contracted number of times.

In addition, in the current digital signage, an advertiser directly requests an advertisement from a media operator and signs a contract with the media operator based on operational information provided by the media operator. Afterwards, the media operator uploads advertising content received from the advertiser via email and the like to a distribution server and then distributes and broadcasts the advertising content. As described above, the current digital signage has the inconvenience of having to go through several steps for advertising. Therefore, there is a need for a method that allows for easier use of digital signage.

Meanwhile, in the case of media provided by small-scale media operators that operate a small number of media, the media value tends to be relatively low. Accordingly, advertisers prefer transactions with large-scale media operators that operate a large number of media. In other words, advertisers prefer transactions with large-space operators (e.g., one large operator that operates 100 media) to a large number of small operators (e.g., 10 small operators that each operate 10 media). Therefore, there is a need for a technology that allows small media operators to combine or integrate media networks to scale up, thereby increasing opportunities for transactions with advertisers.

### DISCLOSURE

### Technical Problem

Embodiments of the present invention to solve such conventional problems are directed to providing a method and system for constructing and integrating a closed peer-to-peer network for digital signage, in which at least one advertiser and at least one media operator construct a closed peer-to-peer network and freely transmit and receive advertising content within the constructed network, and check log reports related to advertising in real time or periodically.

### Technical Problem

A method of constructing a closed peer-to-peer network according to an embodiment of the present invention includes: receiving, by an operating device, a construction request signal for constructing a first network, which is a closed peer-to-peer network, using a plurality of terminals including a first terminal and at least one second terminal from the first terminal; issuing, by the operating device, a unique ticket according to the construction request signal; transmitting, by the operating device, the unique ticket to the plurality of terminals; generating, by the operating device, a terminal list including all of the plurality of terminals, and transmitting the terminal list to the plurality of terminals; and constructing, by the operating device, the first network with the plurality of terminals.

In addition, the method may further include, after the constructing of the first network, receiving, by the operating device, a combination request signal for a combination with at least one second network including one or more terminals from at least one terminal among the plurality of terminals.

In addition, the method may further include, after the receiving of the combination request signal, combining, by the operating device, the first network with the at least one second network to construct an integrated network.

In addition, the constructing of the integrated network may include: issuing, by the operating device, a union ticket to be transmitted to all of the terminals included in the first network and the at least one second network; and transmitting, by the operating device, the union ticket to all of the terminals.

In addition, the method may further include, after the transmitting of the union ticket, generating, by the operating device, an integrated terminal list for all of the terminals included in the integrated network, and transmitting the integrated terminal list to all of the terminals.

In addition, the method may further include, after the constructing of the integrated network, checking, by the operating device, whether a condition for releasing the combination of the first network with the at least one second network is satisfied; and releasing, by the operating device, the combination of the first network with the at least one second network when the condition is satisfied.

In addition, the checking, by the operating device, of whether the condition for releasing the combination of the first network with the at least one second network is satisfied may include confirming, by the operating device, that the condition is satisfied when a time corresponding to time information included in the union ticket has elapsed.

In addition, the method may further include, after the constructing of the integrated network, releasing the combination of the first network with the at least one second network when the operating device receives a request for integration release from any terminal belonging to the integrated network.

Further, a system for constructing a closed peer-to-peer network according to an embodiment of the present invention includes: a plurality of terminals including a first terminal and at least one second terminal; and an operating device configured to receive a construction request signal for constructing a closed peer-to-peer network, which is a first network including the plurality of terminals, from the first terminal, issue a unique ticket according to the construction request signal and transmit the unique ticket to the plurality of terminals, generate a terminal list for the plurality of terminals, and transmit the terminal list to the plurality of terminals to construct the first network.

In addition, the operating device may receive a combination request signal for a combination with at least one second network including one or more terminals from at least one terminal among the plurality of terminals.

In addition, the operating device may combine the first network with the at least one second network to construct an integrated network.

In addition, the operating device may issue a union ticket to be transmitted to all of the terminals included in the first network and the at least one second network, and transmit the union ticket to all of the terminals.

In addition, the operating device may generate an integrated terminal list for all of the terminals included in the integrated network, and transmit the integrated terminal list to all of the terminals.

In addition, the operating device may release the combination of the first network and the at least one second network when a time corresponding to time information included in the union ticket has elapsed.

In addition, the operating device may release the combination of the first network with the at least one second network when the operating device receives a request for integration release from any terminal belonging to the integrated network.

### Advantageous Effects

As is apparent from the above, a method and system for constructing a closed peer-to-peer network according to an embodiment of the present invention can enable at least one advertiser and at least one media operator to construct a closed peer-to-peer network and to freely transmit and receive advertising content within the constructed network, and check log reports related to advertising in real-time or periodically, thereby making it easier to use digital signage and improving the reliability of log reports.

In addition, according to the present invention, small-scale media operators can be unite, thereby providing the same effect as a large-scale media operator.

### DESCRIPTION OF DRAWINGS

FIG. 1 is a diagram illustrating a system for constructing a closed peer-to-peer network according to one embodiment of the present invention.

FIGS. 2 and 3 are diagrams illustrating a system for constructing a closed peer-to-peer network according to another embodiment of the present invention.

FIGS. 4 and 5 are diagrams illustrating a system for integrating and constructing a closed peer-to-peer network according to another embodiment of the present invention.

FIG. 6 is a flowchart for describing a method of constructing a closed peer-to-peer network according to an embodiment of the present invention.

### MODES OF THE INVENTION

Hereinafter, exemplary embodiments according to the present invention will be described in detail with reference to the accompanying drawings. The detailed description set forth below in conjunction with the accompanying drawings is intended to illustrate exemplary embodiments of the invention and is not intended to represent the only embodiments in which the invention may be practiced. In the drawings, parts irrelevant to the description may be omitted for the clarity of explanation, and like numbers refer to like elements throughout the description of the drawings.

Meanwhile, in this specification, a unique value issued to check whether a terminal attempting to participate in a closed peer-to-peer network is permitted to participate is referred to as a ticket. In other words, a terminal with a ticket may participate in the closed peer-to-peer network, and a terminal without a ticket may be denied participation in the closed peer-to-peer network. In this case, a peer may have one or more tickets.

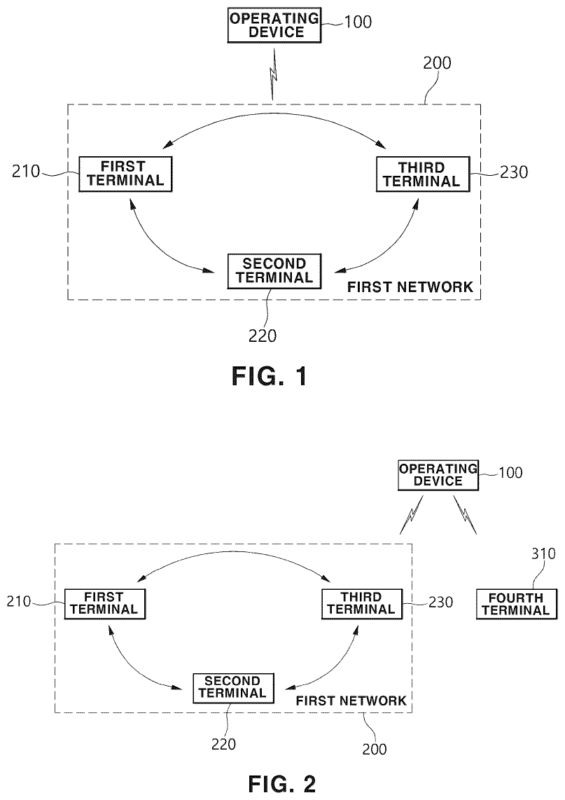

FIG. 1 is a diagram illustrating a closed peer-to-peer network according to an embodiment of the present invention.

Referring to FIG. 1, a system configuring a closed peer-to-peer network according to an embodiment of the present invention may include an operating device 100 and a first network 200 constructed by the operating device 100, and the first network 200 may include a first terminal 210, a second terminal 220, and a third terminal 230.

The operating device 100 is a device such as a server that may construct a plurality of terminals into a single network, and may perform wired and wireless communication with a plurality of terminals. The operating device 100 receives a construction signal for constructing the first network 200 using the first terminal 210, the second terminal 220, and the third terminal 230 from a terminal (e.g., the first terminal 210) that desires to form the first network 200, which is a closed peer-to-peer network.

The operating device 100 issues a unique ticket for the first terminal 210, the second terminal 220, and the third terminal 230 based on the construction signal, and transmits the unique ticket to each of the first terminal 210, the second terminal 220, and the third terminal 230. The operating device 100 constructs the first network 200 including the first terminal 210, the second terminal 220, and the third terminal 230. In this case, the operating device 100 may generate a first terminal list including the first terminal 210, the second terminal 220, and the third terminal 230, and may, whenever at least one of the first terminal 210, the second terminal 220, and the third terminal 230 connects to the first network 200, transmit the first terminal list to the terminal connecting to the first network 200. That is, the operating device 100 may, whenever the first terminal 210, the second terminal 220, and the third terminal 230 each connect to the first network 200, transmit the first terminal list to the terminal connecting to the first network 200. All of the first terminal 210, the second terminal 220, and the third terminal 230 included in the first network 200, due to storing the same unique ticket, may freely transmit and receive data to and from different terminals included in the first network 200.

The first terminal 210, the second terminal 220, and the third terminal 230 are terminals that perform digital signage by constructing the first network 200, and may be electronic devices, such as displays, electronic boards, tablet PCs, computers, and smart phones. For example, the first terminal 210 may be a terminal operated by an advertiser that generates advertising content, and the second terminal 220 and the third terminal 230 may be terminals operated by a media operator equipped with media, such as displays including billboards that may output the advertising content generated by the advertiser.

More specifically, the first terminal 210 may request network construction with the second terminal 220 and the third terminal 230 to output advertising content of the first terminal 210. To this end, the first terminal 210 may check a health index of each of the plurality of media operators and request network construction with the second terminal 220 and the third terminal 230 based on the health index. The health index may be calculated based on the number of media provided by the second terminal 220 and the third terminal 230, advertising content playback log statistics of the second terminal 220 and the third terminal 230, network stability of the second terminal 220 and the third terminal 230, and the like. The health index is an index related to the media operation status of the media operator, and may be calculated higher for a greater number of media and fewer interruptions during the playback of advertising content.

As described above, when the first terminal 210, the second terminal 220, and the third terminal 230 are constructed into the first network 200 under the lead of the first terminal 210, the first terminal 210 may transmit advertising content that the first terminal 210 desires to advertise to the operating device 100, the second terminal 220, and the third terminal 230. Then, the second terminal 220 and the third terminal 230 may output the advertising content transmitted from the first terminal 210.

The second terminal 220 and the third terminal 230 calculate a hash value included in one frame of video data constituting the advertising content while playing the advertising content, and transmit the hash value to the operating device 100. The operating device 100, when the hash value received from the second terminal 220 and the third terminal 230 matches a hash value received from the first terminal 210, generates a log report and transmits the log report to all of the terminals belonging to the first network, including the first terminal 210. In this case, the log report may include information, such as the number of times the advertising content has been output, the time zone in which the advertising content has been output, and the like. As described above, since the log report is transmitted to all of the terminals belonging to the first network, there is an effect of preventing manipulation of the log report in advance (hereinafter referred to as a “log report manipulation prevention effect”). In other words, when the log report is manipulated at one location, the manipulated log report may be different from the log report transmitted to the remaining terminals of the first network, making it easier to identify when the log report has been contaminated (manipulated).

Therefore, since the advertiser operating the first terminal 210 may check the log reports related to the advertising content in real time or periodically through the operating device 100, there is an effect of enhancing the reliability of the log reports. In addition, in the embodiment of the present invention, the first network 200 is illustrated as including the first terminal 210 to the third terminal 230, but the present invention is not limited thereto, and the number of terminals constructing the first network 200 may be changed.

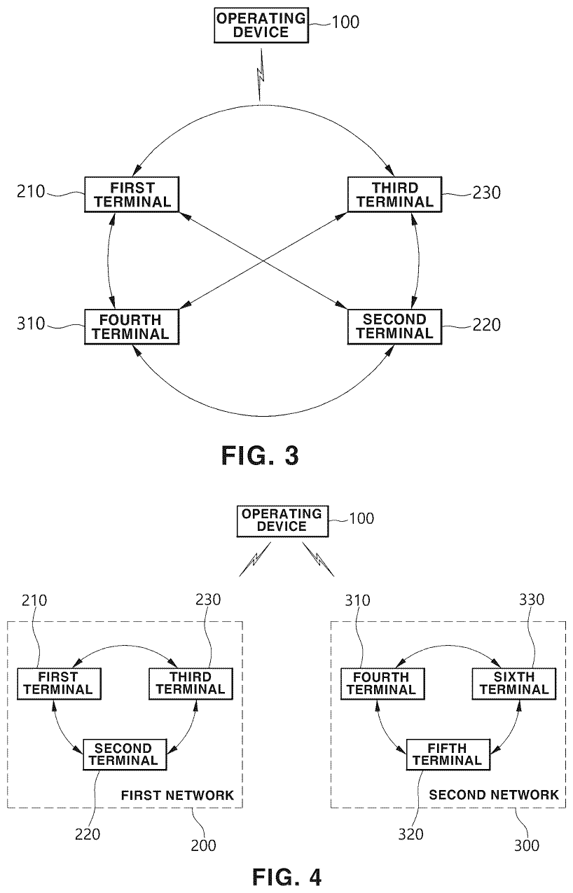

FIGS. 2 and 3 are diagrams illustrating a system for constructing a closed peer-to-peer network according to another embodiment of the present invention.

Referring to FIGS. 2 and 3, the system for constructing a closed peer-to-peer network according to another embodiment of the present invention may include a first network 200 including an operating device 100, a first terminal 210, a second terminal 220, a third terminal 230, and a fourth terminal 310.

Referring to FIG. 2, the operating device 100 receives, from at least one terminal included in the first network 200, a combination signal for combining a network with another terminal while the first network 200 is constructed. In this case, the combination may refer to allowing another terminal that was not included in the first network to participate in the first network, so that the terminal is included in the first network. Hereinafter, a network formed by the participation of the other terminal in the first network is referred to as an “integrated network.”

For example, the operating device 100 may receive, from the first terminal 210 included in the first network 200, a union ticket issuance request signal for network combination with the fourth terminal 310 as a network combination signal. In this case, the network combination signal requested by the first terminal 210 may be a combination signal for transmitting and receiving at least one preset piece of data or unrestricted data to and from the fourth terminal 310, and may be a combination signal for transmitting and receiving at least one piece of data to and from the fourth terminal 310 for a preset period of time.

The operating device 100 may issue a union ticket and transmit the union ticket to the first terminal 210, the second terminal 220, and the third terminal 230 constituting the first network 200, in which the first terminal 210 is included, and the fourth terminal 310 of which combination with the first network 200 is desired based on the union ticket issuance request signal, i.e., a combination signal, received from the first terminal 210. In this case, the union ticket is a ticket different from the unique tickets stored by the terminals included in the first network 200 before the combination, and may be stored by the first terminal 210, the second terminal 220, the third terminal 230, and the fourth terminal 310 included in the newly constructed integrated network as shown in FIG. 3.

More specifically, when a combination signal requested from the first terminal 210 is a combination signal for transmitting and receiving at least one preset piece of data to and from the fourth terminal 310, the operating device 100 may include a hash value of data in the union ticket. In this case, the hash value included in the union ticket is the same as a hash value assigned to data that the first terminal 210 desires to transmit to and receive from the fourth terminal 310. In addition, when the combination signal requested from the first terminal 210 is a combination signal for transmitting and receiving at least one piece of data to and from the fourth terminal 310 for a preset period of time, the operating device 100 may include time information in the union ticket when issuing the union ticket.

The operating device 100 may combine the first network 200 and the fourth terminal 310 to construct a new integrated network as shown in FIG. 3. In this case, the operating device 100 may generate a second terminal list (which may also be referred to as an “integrated terminal list”) including terminals included in the newly constructed integrated network, for example, the first terminal 210 to the fourth terminal 310, and may, whenever each of the terminals connects to the newly constructed integrated network, transmit the second terminal list to the terminal connecting to the new integrated network. All of the terminals included in the new integrated network, due to storing the same union ticket and the second terminal list, may freely perform data transmission and reception with different terminals included in the new integrated network by referring to the second terminal list.

The operating device 100 releases the combination of the integrated network when a condition for releasing the combination of the newly constructed integrated network is satisfied. More specifically, in a case in which the operating device 100 has included time information in the union ticket when issuing the union ticket, the operating device 100 may determine that the condition for releasing the combination is satisfied when a certain amount of time corresponding to the time information included in the union ticket has elapsed.

The operating device 100 may transmit a command to discard the union ticket to all of the terminals belonging to the integrated network, that is, the first terminal 210 to the fourth terminal 310. In this case, the condition for releasing the combination may be whether the time corresponding to the time information included in the union ticket has passed.

In addition, the operating device 100 may receive a request for integration release from any terminal belonging to the integrated network. In this case, the operating device 100 may release the combination of the integrated network.

For example, the first terminal 210 may, after constructing the first network 200 including the second terminal 220 and the third terminal 230 as shown in FIG. 1, lead construction of a new integrated network by combining the fourth terminal 310, which is a terminal operated by an advertiser that generates advertising content, with the first network 200. However, when there is no terminal actually operated by an advertiser, the operating device 100 participates in a new combined network as a virtual fourth terminal 310. Through this, when a new combined network is constructed under the lead of the first terminal 210 to the fourth terminal 310, the first terminal 210 and the fourth terminal 310 may each transmit advertising content of which advertisement is desired to all of the terminals in the integrated network, such as the operating device 100, the second terminal 220, and the third terminal 230.

Then, the second terminal 220 and the third terminal 230 output advertising content transmitted from the first terminal 210 and the fourth terminal 310. The second terminal 220 and the third terminal 230 calculate a hash value of one frame of video data constituting the advertising content while playing the advertising content, and transmit the hash value to the operating device 100. The operating device 100 generates a log report and transmits the log report to all of the terminals of the combined network when the hash values received from the second terminal 220 and the third terminal 230 match hash values received from the first terminal 210 and the fourth terminal 310. In this case, the log report may include information, such as the number of times the advertising content has been output, the time zone in which the advertising content has been output, and the like.

Therefore, since the advertisers (member companies) operating the first terminal 210 and the fourth terminal 310 may check the log report related to the advertising content in real time or periodically through the operating device 100, the reliability of the log reports may be improved, and manipulation of the log reports as described above may be also be prevented. In addition, the first terminal 210 may additionally recruit the fourth terminal 310 that desires to provide advertising content to the second terminal 220 and the third terminal 230, and sign an advertising contract with the fourth terminal 310. Therefore, the first terminal 210 may receive an advertising fee according to the advertising contract from the fourth terminal 310 and distribute the advertising fee to the second terminal 220 and the third terminal 230.

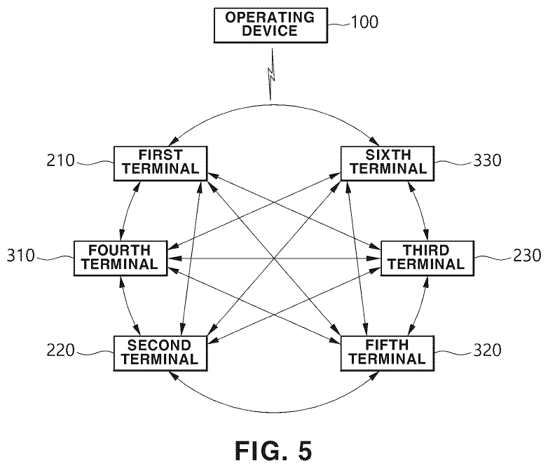

FIGS. 4 and 5 are diagrams illustrating a system for integrating and constructing a closed peer-to-peer network according to another embodiment of the present invention.

Referring to FIGS. 4 and 5, a system for configuring a closed peer-to-peer network according to another embodiment of the present invention may include a first network 200 including an operating device 100, a first terminal 210, a second terminal 220, and a third terminal 230, and a second network 300 including a fourth terminal 310, a fifth terminal 320, and a sixth terminal 330.

Referring to FIG. 4, the operating device 100 receives a combination signal for a combination with different networks from at least one terminal among the terminals included in the first network 200 or from at least one terminal among the terminals included in the second network 300. In this case, the combination may refer to forming a new network that includes all of the terminals of the first network 200 and the second network 300 by combining the first network 200 and the second network 300. Hereinafter, the network formed by combining the first network 200 and the second network 300 is referred to as an “integrated network.”

For example, the operating device 100 may receive a union ticket issuance request signal for combination with the second network 300 including the fourth terminal 310 from the first terminal 210 included in the first network 200 as a network combination signal. In this case, the network combination signal requested by the first terminal 210 may be a combination signal for transmitting and receiving at least preset piece of one data or unrestricted data to and from the terminals included in the second network 300, and may be a combination signal for transmitting and receiving at least one piece of data or unrestricted data to and from the terminals included in the second network 300 for a preset period of time.

The operating device 100 may issue a union ticket and transmit the union ticket to the first terminal 210 to the sixth terminal 330 based on the union ticket issuance request signal, i.e., the integration signal, received from the first terminal 210. In this case, the union ticket is a ticket different from unique tickets stored by the terminals included in the first network 200 and the second network 300, and may be stored by all of the first terminal 210 to the sixth terminal 330 included in the newly constructed integrated network as shown in FIG. 5.

More specifically, when a combination signal requested from the first terminal 210 is a combination signal for transmitting and receiving at least one preset piece of data to and from the terminals included in the second network 300, the operating device 100 may include a hash value in the union ticket. In this case, the hash value included in the union ticket is the same as a hash value assigned to data that the first terminal 210 desires to transmit to and receive from the terminals included in the second network 300. In addition, when the combination signal requested from the first terminal 210 is a combination signal for transmitting and receiving at least one piece of data to and from the terminals included in the second network 300 for a preset period of time, the operating device 100 may include time information in the union ticket when issuing the union ticket.

The operating device 100 may combine (integrate) the first network 200 and the second network 300 to construct a new integrated network as shown in FIG. 5. In this case, the operating device 100 may generate a second terminal list (which may also be referred to as an “integrated terminal list”) including terminals included in the newly constructed integrated network, for example, the first terminal 210 to the sixth terminal 330, and may, whenever each of the terminals connects to the newly constructed integrated network, transmit the second terminal list to the terminal connecting to the new integrated network. All of the terminals included in the new integrated network, due to storing the same union ticket, may freely perform data transmission and reception with different terminals included in the new network by referring to the second terminal list.

The operating device 100 releases the combination (integration) of the integrated network when a condition for releasing the combination of the newly constructed integrated network is satisfied. More specifically, in a case in which the operating device 100 has included time information in the union ticket when issuing the union ticket, the operating device 100 may determine that the condition for releasing the combination is satisfied when a certain amount of time corresponding to the time information included in the union ticket has elapsed.

The operating device 100 may transmit a command to discard the union ticket to the first terminal 210 to the sixth terminal 330. In this case, the condition for releasing the combination may be whether the time corresponding to the time information included in the union ticket has elapsed.

In addition, the operating device 100 may receive a request for integration release from any terminal belonging to the integrated network. In this case, the operating device 100 may release the combination of the integrated network, that is, the combination of the first network 200 and the second network 300.

For example, the first terminal 210 may, after constructing the first network 200 including the second terminal 220 and the third terminal 230 as shown in FIG. 1, lead construction of a new network by combining the second network 300 including the fourth terminal 310 and the fifth terminal 320, which are terminals operated by an advertiser, and the sixth terminal 330, which is a terminal operated by a media operator. Through this, when a new network is constructed with the first terminal 210 to the sixth terminal 330, the first terminal 210, the fourth terminal 310, and the fifth terminal 320 may each transmit advertising content of which advertisement is desired to all of the terminals in the integrated network, including the operating device 100, the second terminal 220, the third terminal 230, and the sixth terminal 330.

Then, the second terminal 220, the third terminal 230, and the sixth terminal 330 output advertising content transmitted from the first terminal 210, the fourth terminal 310, and the fifth terminal 320. The second terminal 220, the third terminal 230, and the sixth terminal 330 calculate a hash value of one frame of the video data constituting the advertising content while playing the advertising content and transmit the hash value to the operating device 100. When the hash values received from the second terminal 220, the third terminal 230, and the sixth terminal 330 match hash values received from the first terminal 210, the fourth terminal 310, and the fifth terminal 320, the operating device 100 generates a log report and transmits the log report to all of the terminals in the integrated network. In this case, the log report may include information, such as the number of times the advertising content has been output, the time zone in which the advertising content has been output, and the like.

Accordingly, since the advertisers (member companies) operating the first terminal 210, the fourth terminal 310, and the fifth terminal 320 may check the log report related to the advertising content in real time or periodically through the operating device 100, the reliability of the log report may be improved, and the manipulation of the log reports as described above may be prevented. In addition, due to the combination of the first network 200 and the second network 300, the first terminal 210 may additionally provide advertising content to the sixth terminal 330 included in the second network 300, and the fourth terminal 310 and the fifth terminal 320 may additionally provide advertising content to the second terminal 220 and the third terminal 230 included in the first network 200, thereby increasing the exposure of the advertising content and improving the advertising effect.

In addition, when the first network 200 and the second network 300 are combined under the lead of the first terminal 210, the first terminal 210 may sign an advertising contract with the fourth terminal 310 and the fifth terminal 320. Therefore, the first terminal 210 may receive an advertising fee according to the advertising contract from the fourth terminal 310 and the fifth terminal 320, and transmit the advertising fee to the second terminal 220, the third terminal 230, and the sixth terminal 330. In addition, the first terminal 210 may additionally provide advertising content to the sixth terminal 330 due to the combination of the first network 200 and the second network 300, and may provide an advertising fee to the sixth terminal 330.

As described above, all of the terminals included in the first network 200 and the second network 300, storing different unique tickets, are provided to store the same union ticket according to the construction of the new integrated network, thereby making it easier to expand the closed peer-to-peer network and eliminating the need for multiple steps for advertising.

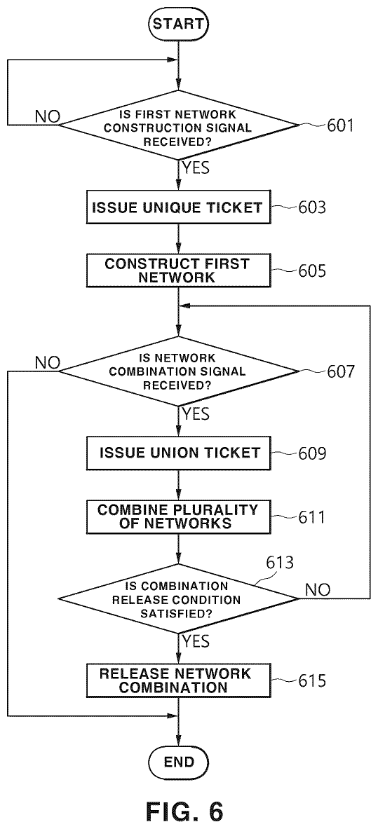

FIG. 6 is a flowchart for describing a method of constructing a closed peer-to-peer network according to an embodiment of the present invention.

Referring to FIGS. 1 to 6, in operation 601, the operating device 100 checks whether a construction signal for constructing a first network 200, which is a closed peer-to-peer network, using the first terminal 210, the second terminal 220, and the third terminal 230 is received from a terminal that desires to form the first network 200, for example, the first terminal 210. When it is found as a result of the checking in operation 601 that the construction signal for constructing the first network 200 is received, the operating device 100 performs operation 603, and when it is found as a result of the checking in operation 601 that the construction signal for constructing the first network 200 is not received, the operating device 100 waits for the reception of the construction signal.

In operation 603, the operating device 100 issues the same unique ticket for the first terminal 210, the second terminal 220, and the third terminal 230, and transmits the unique ticket to each of the first terminal 210, the second terminal 220, and the third terminal 230. Next, in operation 605, the operating device 100 constructs the first network 200 including the first terminal 210, the second terminal 220, and the third terminal 230. In this case, the operating device 100 generates a first terminal list including the first terminal 210, the second terminal 220, and the third terminal 230, and may, whenever at least one terminal among the first terminal 210, the second terminal 220, and the third terminal 230 connects to the first network 200, transmit the first terminal list to the terminal connecting to the first network 200. All of the first terminal 210, the second terminal 220, and the third terminal 230 included in the first network 200, due to storing the same unique ticket, may freely perform data transmission and reception with different terminals included in the first network 200 by referring to the first terminal list.

Next, in operation 607, the operating device 100 checks whether a combination signal for combining the first network 200 and at least one second network 300 is received from at least one terminal among the terminals included in the first network 200. In this case, the second network 300 may be only the fourth terminal 310 as shown in FIG. 2, or may include the fourth terminal 310, the fifth terminal 320, and the sixth terminal 330 as shown in FIG. 4. When the second network 300 includes the fourth terminal 310, the fifth terminal 320, and the sixth terminal 330 as shown in FIG. 4, the second network 300 may be constructed by performing operations 601 to 605 before the performing of operation 607. In this case, in the description of operations 601 to 605 described above, the first network 200, the first terminal 210, the second terminal 220, and the third terminal 230 may be replaced with the second network 300, the fourth terminal 310, the fifth terminal 320, and the sixth terminal 330, respectively.

For example, the first terminal 210 may transmit a combination signal for network combination with the second network 300 to the operating device 100. In this case, the combination signal may be a signal of the first terminal 210 requesting that the operating device 100 issue a union ticket. When it is found as a result of the checking in operation 607 that the combination signal is received, the operating device 100 may perform operation 609, and when it is found as a result of the checking in operation 607 that the combination signal is not received, the operating device 100 may terminate the corresponding process. In addition, the network combination signal requested by the first terminal 210 may be a combination signal for transmitting and receiving at least one preset piece of data to and from the second network 300, and may be a combination signal for transmitting and receiving at least one piece of data to and from the second network 300 for a preset period of time.

In operation 609, the operating device 100 may issue a union ticket and transmit the union ticket to the first terminal 210, the second terminal 220, and the third terminal 230 constituting the first network 200, in which the first terminal 210 is included, as well as the fourth terminal 310 of which combination with the first network 200 is desired or the fourth terminal 310 to the sixth terminal 330 included in the second network 300 of which combine with the first network 200 is desired based on the union ticket issuance request signal received from the first terminal 210, i.e., the combination signal.

More specifically, when a combination signal requested from the first terminal 210 is a combination signal for transmitting and receiving at least one preset piece of data to and from the second network 300, the operating device 100 may include a hash value in the union ticket. In this case, the hash value included in the union ticket is the same as a hash value assigned to at least one piece of data that the first terminal 210 desires to transmit to and receive from at least one terminal included in the second network. In addition, when the combination signal requested from the first terminal 210 is a combination signal for transmitting and receiving at least one piece of data to and from the second network 300 for a preset period of time, the operating device 100 may include time information in the union ticket when issuing the union ticket.

Subsequently, in operation 611, the operating device 100 may combine the first network 200 and the second network 300 to construct a new integrated network. In this case, the operating device 100 may generate a second terminal list for terminals included in the newly constructed integrated network, for example, a second terminal list including the first terminal 210 to the fourth terminal 310, or a second terminal including the first terminal 210 to the sixth terminal 330, and may, whenever each of the terminals connects to the newly constructed integrated network, transmit the second terminal list to the terminal connected to the new integrated network. All of the terminals included in the new integrated network, due to storing the same union ticket, may freely perform data transmission and reception with different terminals included in the new integrated network by referring to the second terminal list.

In operation 613, the operating device 100 checks whether a condition for releasing the combination of the newly constructed integrated network is satisfied, when it is found as a result of the checking that the condition is satisfied, the operating device 100 may perform operation 615, and when it is found as a result of the checking that the condition is not satisfied, the operating device 100 may perform operation 607 again while waiting for a combination signal from another network. In this case, the condition for releasing the combination may be whether the time corresponding to the time information included in the union ticket has elapsed.

More specifically, in a case in which the operating device 100 has included time information in the union ticket when issuing the union ticket, the operating device 100 may determine that the condition for releasing the combination has been satisfied when a certain amount of time corresponding to the time information included in the union ticket has elapsed.

In operation 615, the operating device 100 releases the combination between the first network 200 and the second network 300. In this case, the operating device 100 may transmit a command to discard the union ticket to all of the terminals included in the first network 200 and the second network 300.

Specific embodiments are shown by way of example in the specification and the accompanying drawings and are merely intended to aid in the explanation and understanding of the technical spirit of the present invention rather than limiting the scope of the present invention. Those of ordinary skill in the technical field to which the present invention pertains should be able to understand that various modifications and alterations may be made without departing from the technical spirit or essential features of the present invention.

1. A method of constructing a closed peer-to-peer network, comprising:
receiving, by an operating device, a construction request signal for constructing a first network, which is a closed peer-to-peer network, using a plurality of terminals including a first terminal and at least one second terminal from the first terminal;
issuing, by the operating device, a unique ticket according to the construction request signal;
transmitting, by the operating device, the unique ticket to the plurality of terminals;
generating, by the operating device, a terminal list including all of the plurality of terminals, and transmitting the terminal list to the plurality of terminals; and
constructing, by the operating device, the first network with the plurality of terminals.

2. The method of claim 1, further comprising, after the constructing of the first network,
receiving, by the operating device, a combination request signal for a combination with at least one second network including one or more terminals from at least one terminal among the plurality of terminals.

3. The method of claim 2, further comprising, after the receiving of the combination request signal,
combining, by the operating device, the first network with the at least one second network to construct an integrated network.

4. The method of claim 3, wherein the constructing of the integrated network includes:
issuing, by the operating device, a union ticket to be transmitted to all of the terminals included in the first network and the at least one second network; and
transmitting, by the operating device, the union ticket to all of the terminals.

5. The method of claim 4, further comprising, after the transmitting of the union ticket,
generating, by the operating device, an integrated terminal list for all of the terminals included in the integrated network, and transmitting the integrated terminal list to all of the terminals.

6. The method of claim 3, further comprising, after the constructing of the integrated network,
checking, by the operating device, whether a condition for releasing the combination of the first network with the at least one second network is satisfied; and
releasing, by the operating device, the combination of the first network with the at least one second network when the condition is satisfied.

7. The method of claim 6, wherein the checking, by the operating device, of whether the condition for releasing the combination of the first network with the at least one second network is satisfied includes confirming, by the operating device, that the condition is satisfied when a time corresponding to time information included in the union ticket has elapsed.

8. The method of claim 3, further comprising, after the constructing of the integrated network,
releasing the combination of the first network with the at least one second network when the operating device receives a request for integration release from any terminal belonging to the integrated network.

9. A system for constructing a closed peer-to-peer network, comprising:
a plurality of terminals including a first terminal and at least one second terminal; and
an operating device configured to receive a construction request signal for constructing a closed peer-to-peer network, which is a first network including the plurality of terminals, from the first terminal, issue a unique ticket according to the construction request signal and transmit the unique ticket to the plurality of terminals, generate a terminal list for the plurality of terminals, and transmit the terminal list to the plurality of terminals to construct the first network.

10. The system of claim 9, wherein the operating device receives a combination request signal for a combination with at least one second network including one or more terminals from at least one terminal among the plurality of terminals.

11. The system of claim 10, wherein the operating device combines the first network with the at least one second network to construct an integrated network according to the combination request signal.

12. The system of claim 11, wherein the operating device issues a union ticket to be transmitted to all of the terminals included in the first network and the at least one second network, and transmits the union ticket to all of the terminals.

13. The system of claim 12, wherein the operating device generates an integrated terminal list for all of the terminals included in the integrated network, and transmits the integrated terminal list to all of the terminals.

14. The system of claim 11, wherein the operating device releases the combination of the first network and the at least one second network when a time corresponding to time information included in the union ticket has elapsed.

15. The system of claim 11, wherein the operating device releases the combination of the first network with the at least one second network when the operating device receives a request for integration release from any terminal belonging to the integrated network.
